(19) United States
(12) Patent Application Publication
(10) Pub. No.: US 2006/0094818 A1
(43) Pub. Date: May 4, 2006

(54) Microwave-active silicone elastomers

(75) Inventor: Juergen Weidinger, Polling (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munchen (DE)

(21) Appl. No.: 11/263,229

(22) Filed: Oct. 31, 2005

(30) Foreign Application Priority Data
Nov. 4, 2004 (DE) 10 2004 053 310.5

(51) Int. Cl. C08L 83/04; B32B 27/00

(52) U.S. Cl. 524/588; 524/863; 524/866

(57) ABSTRACT

Silicone elastomers filled with magnetite or with mixtures comprising magnetite have microwave-active, magnetic, or both microwave-active and magnetic properties. The compositions can be easily prepared, and can be used for production of crosslinked extrudates and moldings.

### BACKGROUND OF THE INVENTION

1. Field of the Invention

The invention relates to silicone elastomers that have been filled with magnetite or with mixtures comprising magnetite, and which have microwave-active or magnetic properties, or both microwave-active and magnetic properties, to processes for their preparation, and also to the use of the inventive compositions for production of crosslinked extrudates and moldings.

2. Background Art

Because of their chemical structure, for example their lack of dipole moment, silicone elastomers are not microwave-active. They cannot therefore be either heated or crosslinked via microwave radiation. Nor has there therefore been any description hitherto of their vulcanization via irradiation by microwave energy.

For certain applications, the prior art has previously described silicone elastomers with microwave-active fillers of ferrites, oxidic materials having the formula MₓFe_{y}O_{z}. By way of example, silicone elastomers filled with ferrites are described for the purposes of radiation absorption or damping in the patent specifications U.S. Pat. No. 6,521,150 B1, EP 0 945 916 A2 and DE 37 21 427 A1, and for microwave-initiated vulcanization in patent specifications U.S. Pat. No. 4,980,384 B1 and U.S. Pat. No. 4,460,713 B1, and also for heating or for drying of articles via heating by direct contact with a ferrite-filled silicone or substrate coated therewith in patent specifications EP 1 132 000 A1, DE 196 46 695 A1, EP 0 736 251 A1, FR 2694876 A1, U.S. Pat. No. 4,496,815 B1, and U.S. Pat. No. 4,566,804 B1.

Ferrites form a group of ceramic oxide materials having the general formula (I)
M^{II}Fe^{III}₂O₄ (I)
corresponding to M^{II}O·Fe₂O₃, which comprise permanent magnetic dipoles. Ferrite spinels, where M^{II} is a divalent metal, such as zinc, cadmium, cobalt, manganese, iron, copper, or magnesium, occur with molar ratios of from
1 Fe₂O₃:1 M^{II}O (e.g. magnetite, Fe₃O₄) to
3 Fe₂O₃:2 M^{II}O, and with mixed M^{II} components, e.g. Ni_{0.5}Zn_{0.5}Fe₂O₄.

The ferrites, mostly capable of preparation via sintering of the mixed pulverized oxide components at from 1000 to 1450° C., have good magnetic properties, and a distinction can be made between paramagnetic ferrites, in which M^{II} is zinc or cadmium, for example, and ferromagnetic ferrites, in which M^{II} is manganese, cobalt, or nickel, for example.

Magnetite is a specific case representing ferrites of the general formula (II)
Fe²⁺Fe₂³⁺O₄ (II)
corresponding to FeO.Fe₂O₃, or more simply Fe₃O₄, its structure being that of an inverse spinel whose crystal lattice is cubic-hexakisoctahedral. The structure can have dislocations, or all of the lattice locations may be occupied in accordance with the formula. Magnetite forms non-transparent crystals typical of black iron oxide, with a slight metallic luster. Magnetite is highly ferromagnetic and has good electrical conductivity above about 115-120 K. Natural magnetite often exhibits intergrowths with ulvospinel Fe₂TiO₄ (titanomagnetite having up to 6% of TiO₂) and ilmenite. The theoretical iron content of 72.4% is generally not reached because most magnetite also comprises magnesium, aluminum (mixed crystal formation with spinel), nickel, zinc, chromium, titanium, and up to more than 1.5% by weight of vanadium oxide. However, those skilled in the art are also aware of magnetites of natural and also of industrial origin which comprise only the commonly encountered amounts of heavier metals and therefore have approximately the theoretically possible proportion of iron. The term “ferrites” hereinafter means the group of the ferrites, excluding the specific case of magnetite.

The silicone compositions filled with ferrites and described in the prior art have various disadvantages. The chemical history of ferrite production provides them with proportions of contaminants which are critical, especially for food applications, examples being heavy metals which are mostly not approved for direct contact with foods, and therefore necessitate complicated production processes for the final component, for example requiring production of a multilayer structure. Because ferrites have significant activity only in certain microwave radiation frequency bands, they have only restricted usefulness. Modifications of ferrites to overcome this disadvantage have inadequate long-term stability due, for example, to the fall-off or breakdown of activity on annealing or on heating, or resulting from conversion or decomposition processes. The fillers of the prior art moreover have only limited capability for mixing into the elastomer matrix. Another frequent occurrence is impairment of processibility of the compositions due to the filler, because these, by way of example, generate increased tack or abrasiveness. A notable problem with the silicone rubber compositions of the prior art is impairment of the mechanical properties of the vulcanizates. The fillers of the relevant prior art moreover have impaired surface-treatability, which in turn reduces their level of take-up and linkage into the polymer matrix. Furthermore, the appearance of the pale- to dark-brown ferrites of the prior art cannot be changed and is unattractive, especially for applications in visible regions.

It is possible to embed magnetite into thermosets, for example as described in the patent specification U.S. Pat. No. 4,542,271, or into high-heat-resistant elastomers, such as fluoro rubbers (FKM, FPM), or polyfluorosilicones (FVMQ), but in the former case there is a loss of mechanical performance and flexibility, and sometimes also of food conformity, and in the latter case there is a loss of cost-effectiveness and food-compatibility of the products. Furthermore, there is mostly a complicated attendant method of processing or incorporation. Embedding the materials into thermoplastics or into low-heat-resistant elastomers is not useful because of the heat generated on exposure to microwaves.

### SUMMARY OF THE INVENTION

It was therefore an object of the present invention to provide silicone-containing compositions which, without the disadvantages described above, permit preparation and use of microwave-active, magnetic, or microwave-active and magnetic vulcanizates. Surprisingly, these and other objects are achieved by using magnetite as a filler exclusively, or in combination with additional fillers, e.g. ferrites, in untreated, and in particular, in treated form.

### DETAILED DESCRIPTION OF THE PREFERRED EMBODIMENT(S)

The present invention therefore provides crosslinkable silicone composition comprising:
(A) organopolysiloxanes having at least one organic radical having at least one aliphatic carbon-carbon multiple bond,
(B) from 0 to 100 parts by weight, based on 100 parts by weight of the organopolysiloxane (A), of treated or untreated active fillers, preferably fumed or precipitated silicas,
(C) treated or untreated microwave-active fillers comprising magnetite of the general formula Fe₃O₄, or mixtures thereof, and
(D) a system suitable for crosslinking, which may be a condensation crosslinking system, peroxide-initiated crosslinking system, or noble-metal-complex-catalyzed addition crosslinking system.

The inventive silicone composition can be single-component compositions or else multicomponent compositions. In the latter case, the components of the inventive compositions may comprise any of the constituents in any desired combination.

The inventive silicone-containing compositions preferably comprise, as constituent (A), an aliphatically unsaturated organosilicon compound, and use may be made here of any of the aliphatically unsaturated organosilicon compounds suitable for use in non-crosslinked and crosslinked compositions, or else, for example, silicone block copolymers having urea segments, silicone block copolymers having amide segments and/or having imide segments and/or having ester-amide segments and/or having polystyrene segments and/or having silarylene segments and/or having carborane segments, and silicone graft copolymers having ether groups.

The molar mass of constituent (A) is preferably from 10² to 10⁶ g/mol. In one preferred embodiment, constituent (A) is a relatively low-molecular-weight alkenyl-functional oligosiloxane, such as 1,2-divinyltetramethyldisiloxane. Another preferred embodiment uses high-polymer polydimethylsiloxanes which have Si-bonded vinyl groups within the chain or terminally, an example of their number-average molar mass determined by means of NMR being from 10⁴ to 10⁶ g/mol. The structure of the molecules forming constituent (A) is not of decisive importance; in particular, the structure of an oligomeric or polymeric siloxane can be linear, cyclic, branched, or resin-like (network-like). Linear and cyclic polysiloxanes are preferably composed of units of the formula R₃SiO_{1/2}, R¹R₂SiO_{1/2}, R¹RSiO_{2/2} and R₂SiO_{2/2}, where R and R¹ are as defined above. Branched and network-like polysiloxanes also comprise trifunctional or tetrafunctional units or both units, preference being given here to those of the formulae RSiO_{3/2}, R¹SiO_{3/2} and SiO_{4/2}. It is, of course, also possible to use mixtures of different siloxanes complying with the criteria of constituent (A).

Particular preference is given to the use as component (A) of vinyl-functional substantially linear polydiorganosiloxanes whose viscosity is from 0.01 to 500,000 Pa.s, more preferably from 0.1 to 100,000 Pa.s, in each case measured at 25° C.

The fillers (B) used may comprise any silaceous filler useful in silicone-containing compositions. Examples of reinforcing fillers which can be used as component (B) in the inventive compositions are fumed or precipitated silicas whose BET surface areas are at least 50 m²/g, and also non-silaceous filled such as carbon blacks and activated charcoals, e.g. furnace black and acetylene black, preference being given here to fumed and precipitated silicas whose BET surface areas are at least 50 m²/g.

The silica fillers mentioned may have hydrophilic character or may have been hydrophobicized by known processes. During the mixing process to incorporate hydrophilic fillers it is necessary to add a hydrophobizing agent. The content of actively reinforcing filler (B) in the inventive crosslinkable composition is in the range from 0 to 70% by weight, preferably from 0 to 50% by weight. Components (A) and (B) are commercially available products or products which can be prepared by processes familiar in chemistry.

The microwave-active fillers (C) which are preferably used, comprise mixtures comprising magnetite and, if appropriate, other oxidic compounds of metals, e.g. ferrite. The proportion by weight of the microwave-active fillers (C) is preferably from 0.1 to 500 parts, based on 100 parts by weight of component (A). The average particle size of these microwave-active fillers (C) is preferably from 0.1 to 1000 μm, more preferably from 10 to 500 μm, with any desired particle size distribution.

In order to improve ease of incorporation during mixing, and in order to improve the mechanical properties of the final mixture, these fillers may be treated with suitable chemicals, and this may, by way of example, take place in kneaders, mixers, dissolvers, or autoclaves. Examples of suitable treatment agents are amines, alcohols, or silanes. Preference is given to silanes of the general composition Si[XRₙ]₄, where X is a non-metal atom selected from the group consisting of C, N, O, or P, and R is any desired inorganic or organic radical. The compound is selected in such a way that the molecule becomes absorbed onto the surface of the microwave-active particles and with these enters into a physical bond or into a chemical bond via cleavage of at least one radical at the Si—X or at the X—R bond. The surface treatment with suitable agents on the one hand achieves better dispersion within the polymer matrix, and on the other hand also permits coupling via vulcanization during any subsequent crosslinking. The oxidic metal compounds starting materials are known to those skilled in the art.

The inventive compositions may also comprise, other than components (A) to (D), any further substances useful for preparation of silicone-containing compositions. For example, the inventive silicone-containing composition may optionally comprise, as constituent (E), a proportion of up to 70% by weight, preferably from 0.0001 to 40% by weight, of other additives. These additives may, for example, be non-active fillers, resin-like polyorganosiloxanes other than the siloxanes (A), dispersing agents, solvents, adhesion promoters, pigments, dyes, plasticizers, organic polymers, or heat stabilizers. Among these are additives such as powdered quartz, diatomaceous earth, clays, chalk, lithopones, carbon blacks, graphite, metal oxides, metal carbonates, metal sulfates, metal salts of carboxylic acids, metal dusts, fibers such as glass fibers, synthetic fibers, plastics powders, dyes, or pigments.

Other materials which may also be present include auxiliaries (F) which serve for precise adjustment of processing time, initiation temperature, and crosslinking rate of the inventive compositions, examples being inhibitors, catalysts and cocatalysts, and also crosslinking molecules or hardener molecules, such as H-siloxanes, hydroxysiloxanes, etc.

The inventive organopolysiloxane compositions may, if necessary, be emulsified, suspended, dispersed, or dissolved in liquids. The inventive compositions, in particular as a function of the viscosity of the constituents and also the solids content, may be of low viscosity and pourable, may have a pasty consistency, may be pulverulent, or else may be conformable, high-viscosity compositions, as is known in the case with the compositions termed silicone oils (fluids), single-component, room-temperature-crosslinking compositions (RTV-1), two-component, room-temperature-crosslinking compositions (RTV-2), liquid silicone rubbers (LSR), and high-temperature-crosslinking compositions (HTV). The materials likewise encompass the entire spectrum with respect to the elastomeric properties of the crosslinked inventive silicone compositions, beginning with extremely soft silicone gels and passing by way of rubbery materials and extending to highly crosslinked silicones with glassy behavior.

The inventive silicone-containing compositions may be prepared by known processes, for example via uniform mixing of the individual components. The sequence here is not critical, but preference is given to prior treatment of the microwave-active filler (C) when prior treatment is desired, and to mixing of this treated or untreated with the polymer matrix. The filler may be added in the form of solid or in the form of masterbatch pasted with suitable agents. As a function of the viscosity of (A), the mixing process may employ a stirrer, take place in a dissolver, on a roll, or in a kneader. By way of a further example, the filler (C) may be encapsulated in an organic thermoplastic or thermoplastic silicone resin.

Each of the components (A) to (F) can be a single type of that component or else a mixture composed of at least two different types of that component.

If crosslinkable groups are present, the inventive compositions may, analogous to crosslinkable compositions known hitherto, be crosslinked (vulcanized). The temperatures here are preferably from 40 to 220° C., more preferably from 100 to 190° C., and the pressure is preferably atmospheric pressure or from 900 to 1100 hPa. However, it is also possible to use higher or lower temperatures and pressures. The crosslinking can also be carried out photochemically using high-energy radiation, for example visible light with short wavelengths, and or by UV light, or by using a combination of thermal and photochemical excitation.

An additional advantage of the inventive compositions is their capability, provided by the filler (C), for rapid crosslinking via microwave radiation.

The present invention also provides the use of the crosslinked inventive compositions for production of extrudates and of moldings.

The inventive compositions, to the extent that they are crosslinkable, and also the crosslinked products produced therefrom, can be used for any purpose for which organopolysiloxane compositions crosslinkable to give elastomers, or, for elastomers with the advantage of microwave absorption are useful. This encompasses, by way of example, the silicone coating or impregnation of substrates, the production of moldings, for example by injection molding, vacuum extrusion, extrusion, casting in molds, and compression molding, and castings, and uses as sealing, embedding, or potting compositions. Particular preference is given to moldings and extrudates which are required to have increased thermal conductivity, increased density, for example for insulation and damping or which must be capable of microwave-radiation-induced heating, examples being heater plates, baking molds, insulating sheets, or damping elements, and also parts whose magnetic moment makes them, by way of example, detectable via sensors or capable of magnetic excitation.

An advantage of the inventive compositions is that they can be prepared in a simple process using readily accessible starting materials, and can therefore be prepared cost-effectively. Another advantage is that the increased ease of incorporation of the treated heavy fillers (C) by mixing permits their density to be targeted at up to four times the initial density of silicone composition without microwave-active filler (C), this being impossible with other fillers used in the elastomer sector.

Another advantage of the inventive silicone-containing compositions is that it is possible to cover wide bands of frequencies via variation in the mixing ratio of two or more morphologically different microwave-active fillers, and yet a further advantage is that, even at high proportions of microwave-active fillers, the crosslinked compositions do not exhibit any substantial impairment of mechanical or other physical properties in the final elastomer product when comparison is made with unfilled compositions. Indeed, there is generally an improvement in resistance to hot air. A still further advantage is that crosslinked vulcanizates with exclusively magnetite as the microwave-active filler can be used in direct contact with foods, therefore requiring no use of complicated additional coatings, or substrates such as aluminum, for avoidance of direct contact. Vulcanizates composed of these compositions also have an attractive appearance.

Unless otherwise stated, all of the data concerning parts and percentages in the examples described below are based on weight. Unless otherwise stated, the examples below are carried out at ambient atmospheric pressure, i.e. at about 1000 hPa, and at room temperature, i.e. at about 20° C., or at the temperature generated on combining the reactants at room temperature without additional heating or cooling.

### EXAMPLE 1

To prepare a high-density micro-wave active crosslinkable silicone composition which has improved thermal conductivity and which is suitable for contact with foods, for example in the form of a heating element or baking mold, 100 parts of a poly(dimethyl)(methylvinyl)siloxane are used as initial charge in a kneader at room temperature. At a temperature of 80° C., in portions, 2 parts of a polydimethylsiloxane are added and 15 parts of a fine-particle silica are added, and the material is kneaded for 10 minutes after each addition step. Then the material is again kneaded and heated for 3 hours at 160° C. Then, at room temperature and in portions, 300 parts of magnetite whose average grain size is 150 μm are added and the material is kneaded. Three parts of a silazane and 1 part of water are then added, and the mixture is kneaded for 1 hour at 70° C. After cooling, the mixture can be removed and provided with vulcanization additives on a roll or in a kneader. The composition, whose final vulcanizate hardness is 70 IRHD, has a density of at least 3 g/cm³ and has thermal conductivity improved by a factor of from 2.5 to 3 in comparison with silicone composition without magnetite.

### EXAMPLE 2

To prepare a highly microwave-active crosslinkable silicone composition for engineering items, 100 parts of a poly(dimethyl)methylvinylsiloxane are used as initial charge in a kneader at room temperature. At a temperature of 80° C., in portions, 2 parts of a polydimethylsiloxane are added and 15 parts of a fine-particle silica are added, and the material is kneaded for 10 minutes after each addition step. Then the material is again kneaded and heated for 3 hours at 160° C. Then, at room temperature and in portions, 10 parts of manganoferrite and 50 parts of magnetite, each of whose average grain size is 50 μm, are then added, and the material is kneaded. Two parts of a silazane are then added, and the mixture is kneaded at 70° C. for 1 hour. After cooling, the mixture can be removed and provided with vulcanization additives on a roll or in a kneader. The composition, whose final vulcanizate hardness is 55 IRHD, has a density of 2 g/cm³ and has a high heating rate in commercially available microwave equipment. The high heating rate is apparent, for example, in achievement of a surface temperature of 200° C. after 30 seconds in a microwave when the power used is merely 300 watts.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A crosslinkable silicone composition comprising:
(A) organopolysiloxanes bearing at least one organic radical having at least one aliphatic carbon-carbon multiple bond,
(B) from 0 to 100 parts by weight, based on 100 parts by weight of the organopolysiloxane (A), of treated or untreated fillers,
(C) treated or untreated microwave-active fillers comprising magnetite of the formula Fe₃O₄, or mixtures thereof, and
(D) a condensation crosslinking system, peroxide-initiated crosslinking system, or noble-metal-complex-catalyzed addition crosslinking system.

2. The composition of claim 1, wherein the filler (B) comprises at least one of a fumed silica or a precipitated silica.

3. The crosslinkable silicone composition of claim 1, which is a single-component composition.

4. The crosslinkable silicone composition of claim 1, wherein at least one organopolysiloxane is selected from the group consisting of silicone block copolymers having at least one of urea segments, amide segments, imide segments ester-amide segments polystyrene segments, silarylene segments, and carborane segments, and silicone graft copolymers having ether groups.

5. The crosslinkable silicone composition of claim 1, wherein the organopolysiloxane is a vinyl-functional, substantially linear polydiorganosiloxane whose viscosity is from 0.01 to 500,000 Pa.s at 25° C.

6. The crosslinkable silicone composition of claim 1, wherein the filler (B) comprises fumed or precipitated silicas whose BET surface areas are at least 50 m²/g, carbon blacks, activated carbon, or mixtures thereof.

7. The crosslinkable silicone composition of claim 1, wherein the microwave-active fillers (C) comprise from 0.1 to 500 parts by weight, based on 100 parts by weight of component (A), of magnetite or mixtures comprising magnetite, optionally comprising other oxidic compounds of metals.

8. The crosslinkable silicone composition of claim 1, wherein the average particle size of the microwave-active fillers (C) is from 0.1 to 1000 μm.

9. The crosslinkable silicone composition of claim 1, wherein the microwave-active fillers are surface-treated with amines, with alcohols, or with silanes.

10. The crosslinkable silicone composition of claim 1, which comprises, as further constituents, additives (E) selected from the group consisting of non-active fillers, resin-like polyorganosiloxanes other than (A), dispersing agents, solvents, adhesion promoters, pigments, dyes, plasticizers, organic polymers, and heat stabilizers.

11. The crosslinkable silicone composition of claim 1, which comprises, as further constituents, auxiliaries (F) selected from the group consisting of inhibitors, catalysts, cocatalysts, crosslinking agents, hardeners, H-siloxanes, and hydroxysiloxanes.

12. A process for preparation of a crosslinkable silicone composition of claim 1, comprising mixing components (A) to (D), and also, optionally, (E) and (F).

13. A process for vulcanization of a crosslinkable silicone composition of claim 1, comprising carrying out the crosslinking via microwave irradiation.

14. An extrudate or molding comprising a crosslinkable silicone composition of claim 1.

15. The extrudate or molding of claim 14 which is food-compatible.
